(19) United States
(12) Patent Application Publication
(10) Pub. No.: US 2010/0100684 A1
(43) Pub. Date: Apr. 22, 2010

(54) SET ASSOCIATIVE CACHE APPARATUS, SET ASSOCIATIVE CACHE METHOD AND PROCESSOR SYSTEM

(75) Inventors: Yasuhiko Kurosawa, Kanagawa (JP); Atsushi Kameyama, Tokyo (JP); Shigeaki Iwasa, Kanagawa (JP); Hiroo Hayashi, Kanagawa (JP); Mitsuo Saito, Kanagawa (JP)

Correspondence Address: SPRINKLE IP LAW GROUP, 1301 W. 25TH STREET, SUITE 408, AUSTIN, TX, 78705, US

(73) Assignee: Kabushiki Kaisha Toshiba, Tokyo (JP)

(21) Appl. No.: 12/580,720

(22) Filed: Oct. 16, 2009

(30) Foreign Application Priority Data
Oct. 20, 2008 (JP) 2008-269939

(51) Int. Cl. G06F 12/08; G06F 12/00

(52) U.S. Cl. 711/128; 711/E12.001; 711/E12.018

(57) ABSTRACT

A set associative cache memory includes a tag memory configured to store tags which are predetermined high-order bits of an address, a tag comparator configured to compare a tag in a request address (RA) with the tag stored in the tag memory and a data memory configured to incorporate way information obtained through a comparison by the tag comparator in part of a column address.

### CROSS REFERENCE TO RELATED APPLICATION

This application is based upon and claims the benefit of priority from the prior Japanese Patent Application No. 2008-269939 filed in Japan on Oct. 20, 2008; the entire contents of which are incorporated herein by reference.

### BACKGROUND OF THE INVENTION

1. Field of the Invention

The present invention relates to a set associative cache apparatus, a set associative cache method and a processor system.

2. Description of the Related Art

Conventionally, a set associative cache memory logically has the same number of sets of tag memories and data memories as ways. When a cache is accessed, addresses are broken down using address bits corresponding to a capacity obtained by dividing an entire cache capacity by the number of ways as a boundary whose MSB side is assumed to be a tag and whose LSB side is assumed to be an index. A tag memory and a data memory are subtracted from a value obtained by dividing the index by an access unit, an output from the tag memory is compared with a tag generated from the address of the accessed cache and if the output and the address match, a cache hit results. Furthermore, data corresponding to a target address is obtained by selecting an output from the data memory based on a way number of the matching tag (e.g., see “Computer Architecture” Kiyoshi Shibayama, Ohmsha, Ltd. Mar. 20, 1997, p.292 and “Computer Organization and Design—The Hardware/Software interface—second edition” David. A. Patterson and John L. Hennessy (1998 Morgan Kaufmann: ISBN 1-55860-428-6) p. 574 FIG. 7.19).

However, the method can use only data corresponding to a number of bits obtained by dividing the number of output bits from the data memory by the number of ways as data.

For example, in the case of a cache in a 4-way set associative configuration in which an address outputted from a processor has 32 bits, the total capacity is 256 k bytes, a data access width of the cache is 128 bits (16 bytes) and a cache line size is 128 bytes (1024 bits), the capacity of the cache per way is 256 k bytes/4 ways is 64 k bytes.

That is, since there is a 16-bit address space, the number of bits of the tag of the tag memory is 32 bits−16 bits=16 bits. Furthermore, since the address space of the cache per way is 64 k bytes (16 bits) and the cache line size is 128 bytes (address space is 7 bits), the number of bits of the index is 16 bits−7 bits=9 bits.

On the other hand, since the data access unit is 16 bits (address space is 4 bits), the data memory has 16 bits−4 bits=12 bits.

For convenience, suppose a cache state is divided into a tag memory and a state memory having the same address and has such a configuration that a data memory address is divided into 9 bits corresponding to an index of the tag memory and 3 bits of a block offset in a cache line.

Here, each data memory has a data port of 128 bits in width and outputs read data of a total of 512 bits for four ways, but since the output of the read data is selected by a way number from the tag memory, only 128 bits can be used. That is, read data outputted from respective data memories correspond to different addresses, and therefore there is a problem that a maximum of only one of four sets of data memory outputs can be used.

### BRIEF SUMMARY OF THE INVENTION

According to an aspect of the present invention, it is possible to provide a set associative cache apparatus made up of a plurality of ways, including a tag memory configured to store tags which are predetermined high-order bits of an address, a tag comparator configured to compare a tag in a request address with the tag stored in the tag memory, and a data memory configured to incorporate way information obtained through a comparison by the tag comparator in part of the address.

### BRIEF DESCRIPTION OF THE DRAWINGS

FIG. 1 is a block diagram showing a configuration of a processor system according to a first embodiment of the present invention;

FIG. 2 is a configuration diagram illustrating a configuration of a cache memory 12;

FIG. 3 is a diagram illustrating address mapping;

FIG. 4 is a diagram illustrating a configuration of a command decoder of a data memory;

FIG. 5 is a flowchart illustrating an example of an access flow of the data memory; and

FIG. 6 is a configuration diagram illustrating a configuration of a cache memory according to a second embodiment of the present invention.

### DETAILED DESCRIPTION OF THE INVENTION

Hereinafter, embodiments of the present invention will be explained in detail with reference to the accompanying drawings.

### FIRST EMBODIMENT

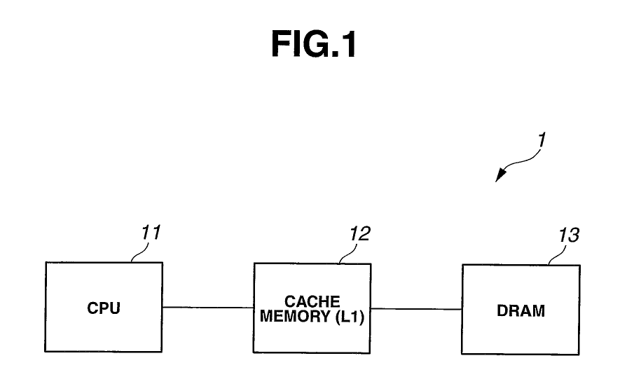

First, a configuration of a processor system according to a first embodiment of the present invention will be explained based on FIG. 1. FIG. 1 is a configuration diagram showing the configuration of the processor system according to the first embodiment of the present invention.

As shown in FIG. 1, a processor system 1 is configured by including a central processing unit (hereinafter referred to as “CPU”) 11, a cache memory 12 of level 1 (L1) and a DRAM 13 as a main memory. The cache memory 12 and the DRAM 13 are mutually connected via a bus. The CPU 11 is a so-called CPU core.

The present embodiment shows an example where one CPU 11 accesses the DRAM 13, but a multi-core configuration may also be adopted where there are a plurality of pairs of CPU 11 and cache memory 12 and the plurality of pairs are connected to one DRAM 13 via a system bus or the like.

The CPU 11 as a control section reads and executes instructions or data stored in the main memory 13 as a main storage device via the cache memory 12 including a cache memory control circuit. The CPU 11 reads instructions or data (hereinafter simply referred to as “data”) necessary to execute a program from the cache memory 12 as the cache device and executes the program.

The cache memory 12 reads the instructions or data stored in the main memory 13 in predetermined block units and writes the instructions or data in a predetermined storage area.

The CPU 11 outputs a request address (RA) to the cache memory 12 to specify data necessary to execute the program and if data corresponding to the request address (RA) inputted to the cache memory 12 exists, the cache memory 12 outputs the data to the CPU 11. On the other hand, when there is no data stored in the cache memory 12, the cache memory 12 reads the data from the DRAM 13 through refilling processing, writes the data in a predetermined storage area of the cache memory 12 and outputs the corresponding data to the CPU 11.

The request address RA that the CPU 11 outputs to the cache memory 12 may be any one of a real address and a virtual address.

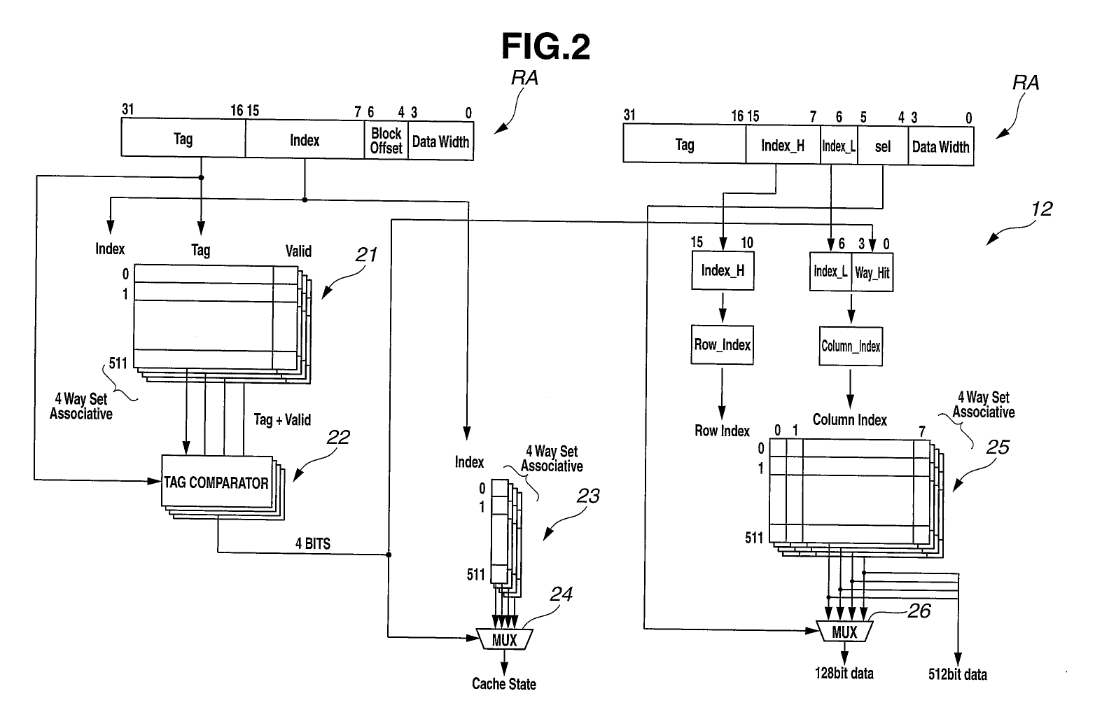

FIG. 2 is a configuration diagram illustrating a configuration of the cache memory 12.

As shown in FIG. 2, the cache memory 12 is configured by including a tag memory 21, a tag comparator 22, a cache state memory 23, a multiplexer (hereinafter referred to as “MUX”) 24, a data memory 25 and a MUX 26.

The cache memory 12 realizes a function as an L1 cache by means of a cache memory in a 4-way set associative configuration. The capacity of the cache memory 12 as the L1 cache is 256 KB (kilobytes; the same will apply hereinafter). Each cache line has 128 B and each block in each cache line has 128 bits.

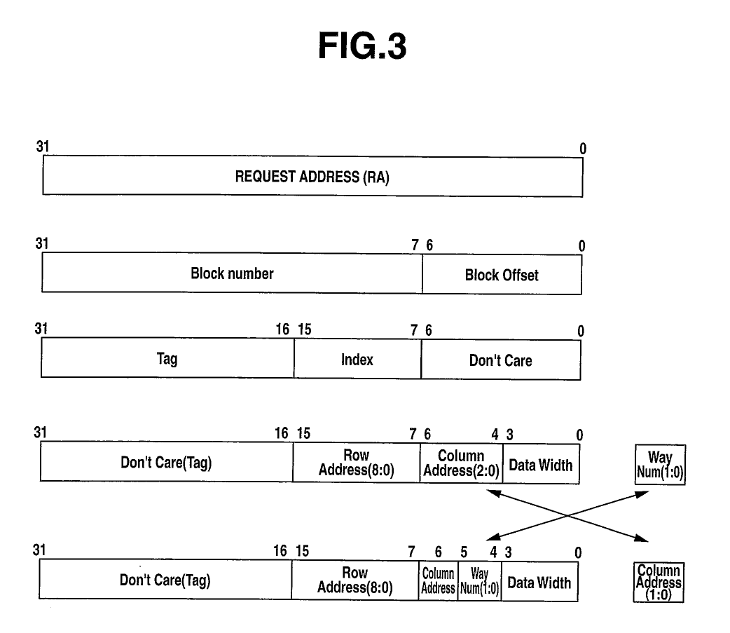

Suppose the request address (RA) outputted from the CPU 11 has 32 bits. The address mapping of the request address (RA) will be explained in detail using FIG. 3 which will be described later.

The tag memory 21 includes a tag memory for each way and each tag memory can store tags, Valid (V) that indicates whether or not each entry is valid and state information such as “state” that indicates a state. The tag is data corresponding to high-order bits (31:16) in the request address (RA). An index (Index) of each tag memory is specified by bits (15:7) in the request address (RA). The tag and Valid of each tag memory are outputted to the four tag comparators 22.

The high-order bits (31:16) in the request address (RA) are supplied to each tag comparator 22. Each tag comparator 22 compares a tag outputted from each tag memory with the high-order bits (31:16) in the request address (RA). Based on such a comparison, each tag comparator 22 judges a cache hit or cache miss and outputs the judgment result of cache hit or cache miss to the data memory 25. Furthermore, upon judging a cache hit, each tag comparator 22 outputs 4-bit way hit information to the MUX 24 and the data memory 25.

The cache state memory 23 includes a cache state memory for each way. Each piece of data of each cache state memory 23 is specified by 9 bits (15:7) in the request address (RA) and outputs each piece of the specified data to the MUX 24. The cache state memory 23 is a memory for performing cache state management in cache line units (that is, cache block units).

The MUX 24 with four inputs and one output outputs data selected by the way hit information from the tag comparator 22 out of the respective pieces of data outputted from the cache state memory 23.

The data memory 25 includes a data memory for each way. Each data memory manages each piece of data in 128 byte units. Each piece of data of each data memory is specified by a row index which is a row address and a column index which is a column address.

For the row address, 9 bits (15:7) in the request address (RA) are used. On the other hand, for the column address, one bit (6) in the request address (RA) and four bits which constitute way hit information from the tag comparator 22 are used. Two bits (5:4) in the request address (RA) are supplied to the MUX 26 as a data select signal.

Conventionally, three bits (6:4) in the request address (RA) specify a column address and the output from the data memory is selected by a 4-bit way hit signal. In the present embodiment, the low-order two bits (5:4) of three bits (6:4) are used as a data select signal and the 4-bit way hit information is used instead of the low-order 2 bits (5:4). The low-order 2 bits (5:4) are decoded by a decoder (not shown) in the data memory 25 and constitute a 4-bit data selection signal. Therefore, the present embodiment uses the 4-bit way hit information from the tag comparator 22 instead of the low-order two bits (5:4) to omit the processing of decoding in the data memory 25. Each piece of data of four sets of 128 bits outputted from the data memory 25 is inputted to the MUX 26 based on the row address and column address. Furthermore, according to the present configuration, the data memory 25 can also output 512-bit data as is.

The MUX 26 with four inputs and one output outputs the 128-bit data selected by two bits (5:4) in the request address (RA) out of the respective pieces of data outputted from the data memory 25.

FIG. 3 is a diagram illustrating address mapping.

The request address (RA) from the CPU core is outputted with 32 bits.

When the request address (RA) from the CPU core is outputted to the cache region, the address of the CPU 11 is divided into a block number (Block Number) indicating the block number of a cache line and a block offset (Block Offset) indicating an offset in the block using the cache line size 128 B as a boundary.

Addresses are broken down for access of the tag memory 21 as follows. The cache line size of 128 B or less is ignored (Don't Care). The MSB side of a 64-KB boundary resulting from dividing the cache capacity 256 KB by the number of ways which is 4 is assumed to be a tag (Tag). Since the tag is compared by the tag comparison section 22 and used to judge a cache hit or cache miss, the tag is stored in the tag memory 21. An address between the 64-KB boundary and 128-B boundary is used as an index (Index) and used as an address of the tag memory 21.

Next, addresses are broken down for access of the data memory 25 as follows. The MSB side of a 64-KB boundary resulting from dividing the cache capacity 256 KB by the number of ways which is 4 is assumed to be don't care and ignored. Suppose an address between the 64-KB boundary and 128-B boundary is a row addresses. Suppose an address between the 128-B boundary and the 16-B boundary is a column address. An address of 16 B or below is a data width, where, for example, write enable is generated in a write.

What is different from prior arts is that two bits on the LSB side of column addresses are assigned to a data memory number and way hit information which is way information outputted from the tag memory 21 is assigned to information corresponding to the lacking two bits.

The data memory is configured to break down an address given from outside into a row address and a column address, select a word in the data memory outputted by giving a row address and select a bit from the word by giving a column address. Therefore, the data memory has such a structure that a column address is given with a lapse of a certain access time after giving a row address. When write data is written into the data memory, a write enable is given substantially simultaneously with the column address, a bit specified at the column address is rewritten with the write data given from the outside out of the word read at the row address from the data memory cell. Therefore, in the data memory, the column address, write enable and write data are given after the row address. In other words, it is possible to adopt a configuration in which it is judged whether or not a write can be actually performed after a row address is given speculatively beforehand until a column address or a write enable is given. That is, a row address is given to the data memory substantially at the same time as the tag memory is accessed and if a cache hit or a cache miss and a hit way number can be known in the tag memory by the time the column address and write enable are given, it is possible to speculatively give a row address and shorten the access time. No read corrupts data even in the case of a cache miss, whereas a write corrupts data, and it is therefore necessary to design the high-speed cache memory so as to be able to judge a cache hit and select a way at the time of a write.

In the present embodiment, a way number is assigned to the two bits on the LSB side of a column address, but since the way number needs only to be determined before timing of giving a column address, the way number need not be known at the timing of giving a row address. At the time of a write, a write enable is created from a cache hit or cache miss information and way number information, but since the access result of the tag memory 21 is used in the same way as the column address, using way information for the column address never deteriorates the timing of a write into the data memory. That is, when the write enable signal for which timing has been originally determined and the column address have equivalent delays, using the way information never constitutes a factor of deteriorating the timing.

In the conventional address assignment, since the way number of the tag memory matches the data memory number, it is not until the tag memory is subtracted that it is possible to judge in which data memory the data requested by the processor exists.

The present embodiment generates a data select signal for specifying which data memory is selected according to the request address (RA) from the CPU 11, and can thereby judge which data memory is accessed without accessing the tag memory 21. That is, since a data memory to be accessed can be immediately known from the address information of the request address (RA) from the CPU 11, no row address need to be supplied to the data memory that has no possibility of being accessed either, and power consumption can be reduced compared to the conventional configuration.

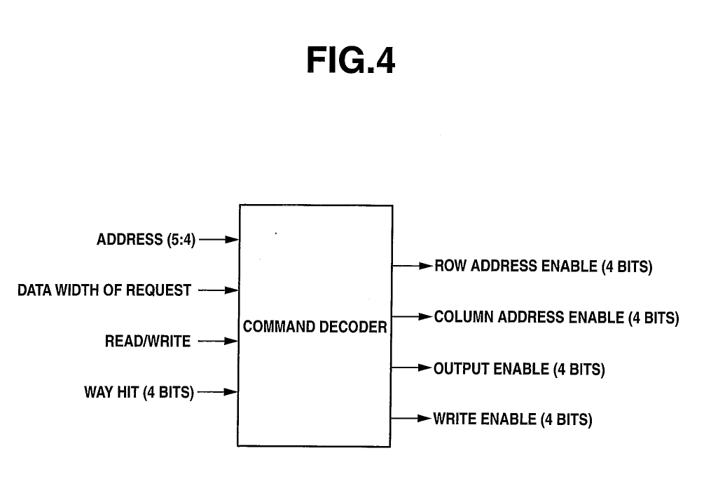

FIG. 4 is a diagram illustrating a configuration of a command decoder of the data memory. Addresses (5:4), data width of a request, read or write signal and way hit information are supplied to the command decoder of the data memory 25 shown in FIG. 4. The command decoder outputs a row address enable, column address enable, output enable and write enable to the data memory 25 based on these inputs.

What is different from the prior arts is that the addresses (5:4) exist in the input. The addresses (5:4) are used to judge to which SRAM an address belongs as described above. Furthermore, it is also judged according to the data width whether to use only one data memory or four data memories.

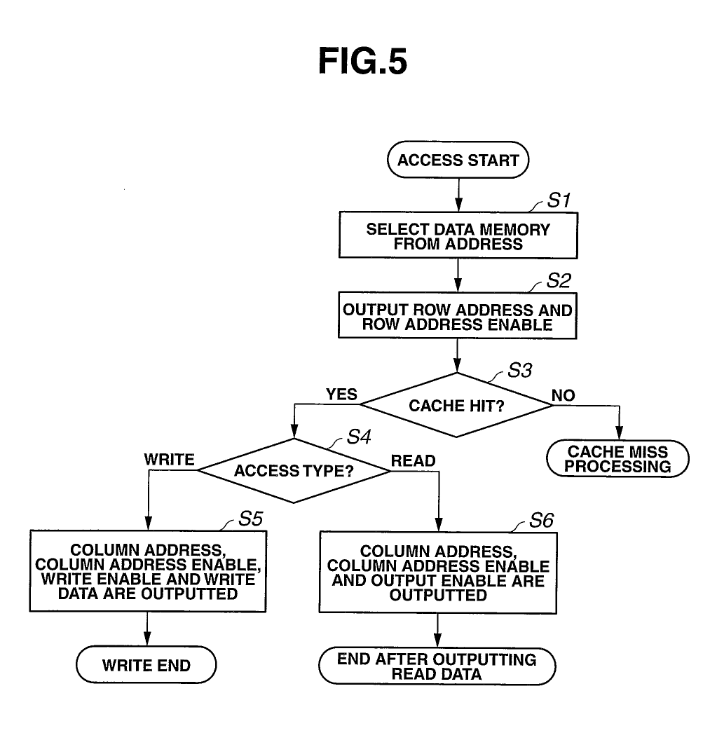

FIG. 5 is a flowchart illustrating a flow of access to a data memory. A data memory is selected from the addresses (5:4) in the request address (RA) (step S1). A row address and a row address enable are outputted to the selected data memory (step S2). The tag comparator 22 judges whether or not a cache hit is found (step S3). When no cache hit is found, the judgment result is NO and cache miss processing is executed. When a cache hit is found, the judgment result is YES and it is judged whether the access type is read or write (step S4). When the access type is write, a column address, column address enable, write enable and write data are outputted to the data memory (step S5) and the write ends. On the other hand, when the access type is read, a column address, column address enable and output enable are outputted to the data memory (step S6), read data is outputted and the read ends.

According to the conventional cache configuration, no data memory can be selected until the tag memory is subtracted and a way hit signal to be outputted is outputted from a comparison with a tag of a request. For this reason, in order to shorten the access time of the cache, it is necessary to output row addresses, speculatively access all four data memories and select one of the outputs of the four data memories using a way hit signal. In the case of write access in particular, if a write enable is asserted, data in the data memory is updated, and therefore the way hit signal needs to be determined by the time the write enable is asserted.

Since the present embodiment uses part of an address outputted by the CPU 11 as a data select signal, it is known beforehand “which data memory should be accessed when a cache hit is found.” That is, when a request is sent from the CPU 11, it is possible to specify a data memory not likely to be accessed by only seeing the address and the data width of the access, and therefore if there is access in a data size equal to or less than the data width of the data memory, it is possible to judge that a row address and enable are given to only one of the four data memories and no address needs to be given to the other three data memories. That is, the cache memory 12 of the present embodiment activates only one data memory which is likely to be accessed out of the four data memories and does not activate the three other data memories which are not likely to be accessed, and therefore power consumption can be suppressed compared with the conventional configuration. According to the present embodiment, unless way hit information is received from the tag memory 21, no column address is determined either in a read or in a write and it is not possible to access any data memory. However, if it is noted that even in the conventional cache configuration, no write enable can be asserted unless a way hit signal is determined in a write, it is understandable that the timing design in the cache configuration of the present embodiment is substantially the same as that in the prior arts.

As shown above, addresses are recombined in the cache memory 12 as described above and the output data from the four data memories are thereby changed as follows. For example, when way 0, index 0 and offset 0 of the data memory are accessed, if the four data memories are noted as (way, index, offset), (0,0,0), (1,0,0), (2,0,0) and (3,0,0) are outputted in the prior arts. These are data that belong to different cache lines. Therefore the outputs of the four data memories are only valid for 128 bits that belong to way 0.

In contrast, (0,0,0), (0,0,1), (0,0,2) and (0,0,3) are outputted in the present embodiment using the same notation method. These are data that belong to the same cache line, and of the outputs of the four data memories, only 128 bits belonging to way 0 may also be used or the four data memories may be combined and used as 512-bit data.

Thus, the set associative cache changes the address generation method for the data memory so as to use the way hit information which is way information as part of an address of the data memory and use part of an address conventionally used as an index of the data memory as a data select signal instead of way information, and can thereby use all output signals from the data memory of the set associative cache as valid signals.

Therefore, the set associative cache apparatus of the present embodiment replaces part of an address of the data memory by way information, and can thereby simultaneously use all outputs of a plurality of ways. Furthermore, when a necessary data width is half or below all the outputs of a plurality of ways, the set associative cache apparatus of the present embodiment can activate only some of the plurality of ways having a possibility that data may exist using only the requested addresses.

Furthermore, the present embodiment provides a 128-bit data port that selects data from the four data memories by the MUX 26 and a 512-bit data port that can use all data from the four data memories. Therefore, the present embodiment is applicable to a processor requiring different data widths, for example, with a 128-bit data port inputting data to an ALU of the processor and the 512-bit data port inputting data to an SIMD calculation apparatus or the like.

Furthermore, when, for example, the cache memory 12 is shared for data and instructions, the present embodiment is also valid for a Princeton processor such that the 128-bit port is used for a data buffer and the 512-bit port is used for an instruction buffer.

A processor that requires different data widths for a normal ALU and SIMD calculator can supply data of a large bit width to the SIMD calculator while keeping the amount of hardware of the cache substantially constant.

Furthermore, when the cache 12 of the present embodiment is applied to a Princeton processor whose cache is shared by instructions and data, it is possible to increase a bandwidth for executing instruction fetches by assigning a port of a large bit width to instruction fetches of strong spatial locality and secure a necessary bandwidth with a smaller amount of hardware than a Harvard processor which requires dedicated caches for instructions and data respectively.

### SECOND EMBODIMENT

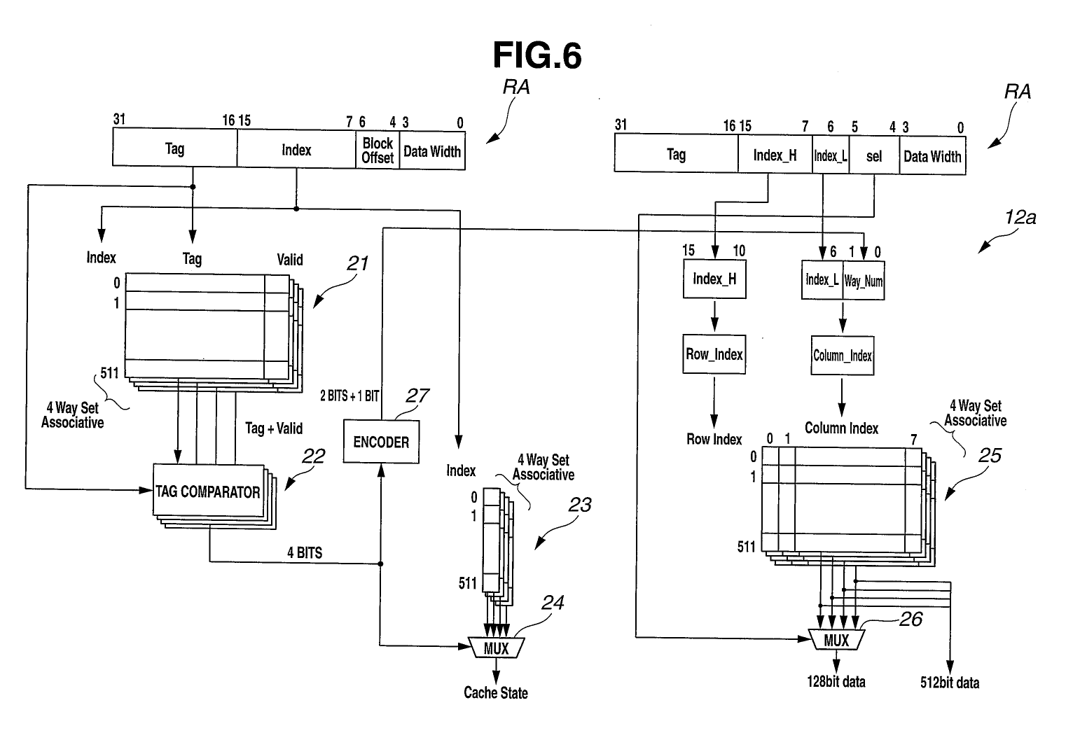

Next, a second embodiment will be explained. FIG. 6 is a configuration diagram illustrating a configuration of a cache memory according to the second embodiment of the present invention. Since the processor system of the present embodiment is the same as that of the first embodiment, explanations thereof will be omitted. Furthermore, the same components in FIG. 6 as those in FIG. 2 will be assigned the same reference numerals and explanations thereof will be omitted.

As shown in FIG. 6, a cache memory 12a of the present embodiment is configured with an encoder 27 added to the cache memory 12 in FIG. 2.

The encoder 27 encodes 4-bit way hit information outputted from a tag memory 21. 4-bit way hit information from the encoder 27 and the tag memory 21 is converted to 2-bit way number (Way Num) information and 1-bit hit information. The way number information as way information is used as part of a column address of a data memory 25. That is, 2-bit way number information is used instead of bits (5:4) in a request address (RA).

The 1-bit hit information is used to transmit information on a cache hit or cache miss to a CPU 11. Though not explicitly illustrated in FIG. 6, a write enable signal or output enable signal to the data memory 25 or the like is generated based on the encoded way number information and hit information.

Since other components and operations are similar to those of the first embodiment, explanations thereof will be omitted.

As stated above, by changing the address generation method for the data memory so as to use way number information which is way information as part of an address of the data memory in a set associative cache and use part of an address conventionally used as an index of the data memory as a data select signal instead of way information, it is possible to use all output signals from the data memory of the set associative cache as valid signals.

Therefore, according to the set associative cache apparatus of the present embodiment, it is possible to simultaneously use all outputs of a plurality of ways by replacing part of an address of the data memory by way information in the same way as in the first embodiment.

The steps in the flowchart of the present specification may be changed in order of execution so that a plurality of steps are executed simultaneously or steps are executed in order which differs every time each step is executed unless the change has adverse effects on the nature of the steps.

The present invention is not limited to the above described embodiments, but various modifications and alterations or the like can be made without departing from the spirit and scope of the present invention.

What is claimed is:

1. A set associative cache apparatus made up of a plurality of ways, comprising:
a tag memory configured to store tags which are predetermined high-order bits of an address;
a tag comparator configured to compare a tag in a request address with the tag stored in the tag memory; and
a data memory configured to incorporate way information obtained through a comparison by the tag comparator in part of the address.

2. The set associative cache apparatus according to claim 1,
wherein information on a select signal to select the plurality of ways is included in the request address,
the part of the address comprises predetermined low-order bits of the address to specify data in the data memory, and
data is simultaneously accessed from the plurality of ways by incorporating the way information in the predetermined low-order bits instead of the information on the select signal.

3. The set associative cache apparatus according to claim 2, wherein a way to be operated is determined from the plurality of ways based on the information on the select signal included in the request address and operation of the way to be operated is started based on the determination result.

4. The set associative cache apparatus according to claim 2, wherein information on a data width necessary to access the data memory is included in the request address, and
a way necessary for access is selected from the plurality of ways or a way to be operated is determined from the plurality of ways based on the information on the data width included in the request address and operation of the way to be operated is started based on the determination result.

5. The set associative cache apparatus according to claim 2, further comprising a selector configured to select any one piece of data from the plurality of ways,
wherein the selector outputs data selected by the select signal from data of the plurality of simultaneously accessed ways.

6. The set associative cache apparatus according to claim 1, wherein the way information is way hit information or way number information obtained by encoding the way hit information.

7. The set associative cache apparatus according to claim 1, wherein the request address is a real address or a virtual address.

8. A set associative cache method for accessing data from a set associative cache apparatus made up of a plurality of ways, comprising:
storing tags which are predetermined high-order bits of an address;
comparing a tag in a request address with the tag stored in the tag memory; and
incorporating way information obtained through a comparison in part of an address to specify data in a data memory.

9. The set associative cache method according to claim 8,
wherein information on a select signal to select the plurality of ways is included in the request address, and
a way to be operated is determined from the plurality of ways based on the information on the select signal included in the request address and operation of the way to be operated is started based on the determination result.

10. The set associative cache method according to claim 8,
wherein information on a data width necessary to access the data memory is included in the request address, and
a way necessary for access from the plurality of ways is selected or a way to be operated is determined from the plurality of ways based on the information on the data width included in the request address and operation of the way to be operated is started based on the determination result.

11. The set associative cache method according to claim 8, wherein the way information is way hit information or way number information obtained by encoding the way hit information.

12. The set associative cache method according to claim 8, wherein the request address is a real address or a virtual address.

13. A processor system comprising:
a main storage apparatus configured to store instructions or data necessary to execute a program;
a set associative cache apparatus made up of a plurality of ways and configured to read and store instructions or data necessary to execute the program from the main storage apparatus in predetermined block units; and
a control section configured to output a request address to specify instruction or data necessary to execute the program to the cache apparatus, read the instructions or the data corresponding to the request address from the cache apparatus and execute the program,
wherein the set associative cache apparatus comprises:
a tag memory configured to store tags which are predetermined high-order bits of an address;
a tag comparator configured to compare a tag in the request address with the tag stored in the tag memory; and
a data memory configured to incorporate way information obtained through a comparison by the tag comparator in part of an address.

14. The processor system according to claim 13,
wherein information on a select signal to select the plurality of ways is included in the request address,
the part of the address comprises predetermined low-order bits of the address to specify data in the data memory, and
data is simultaneously accessed from the plurality of ways by incorporating the way information in the predetermined low-order bits instead of the information on the select signal.

15. The processor system according to claim 14, wherein a way to be operated is determined from the plurality of ways based on the information on the select signal included in the request address and operation of the way to be operated is started based on the determination result.

16. The processor system according to claim 14, wherein information on a data width necessary to access the data memory is included in the request address, and
a way necessary for access is selected from the plurality of ways or a way to be operated is determined from the plurality of ways based on the information on the data width included in the request address and operation of the way to be operated is started based on the determination result.

17. The processor system according to claim 14, further comprising a selector configured to select any one piece of data from the plurality of ways,
wherein the selector outputs data selected by the select signal from data of the plurality of simultaneously accessed ways.

18. The processor system according to claim 13, wherein the way information is way hit information or way number information obtained by encoding the way hit information.

19. The processor system according to claim 13, wherein the request address is a real address or a virtual address.

20. The processor system according to claim 13, wherein when the instructions or the data corresponding to the request address are not stored, the set associative cache apparatus reads the instructions or the data corresponding to the request address from the main storage apparatus and outputs the instructions or the data to the control section.
